(19) United States
(12) Patent Application Publication
(10) Pub. No.: US 2004/0042414 A1
(43) Pub. Date: Mar. 4, 2004

(54) Method and system for establishing communication over a data packet network using callobjects

(76) Inventors: Christophe Bouret, Helsinki (FI); Pekka Pessi, Helsinki (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/430,225

(22) Filed: May 7, 2003

Related U.S. Application Data
(63) Continuation-in-part of application No. 09/375,806, filed on Aug. 17, 1999, now abandoned.

(51) Int. Cl. H04L 12/28

(52) U.S. Cl. 370/252; 370/401

(57) ABSTRACT

A method and system for establishing communication over a data packet network which reduces transmission congestion on the data packet network, increases security options for call receivers on the data packet network and ensures more accurate billing procedures for facilitators of the data packet network. CallObject specifying customizing call receiving parameters are downloaded by a calling party who then requests communication with the call receiving party, if there is compliance between the CallObject of the call receiving party and the CallObject of the calling party which specifies the calling capabilities of the calling party.

The present invention is a Continuation In Part and claims the benefit of U.S. patent application Ser. No. 09/375,806 filed Aug. 17, 1999, the contents of which is expressly incorporated by reference in its entirety.

### BACKGROUND OF THE INVENTION

The present invention relates to a method and system for establishing communication over a data packet network. In particular, the method and system for establishing communication over a data packet network in accordance with the present invention reduces transmission congestion on the data packet network, increases security options for call receivers on the data packet network and ensures more accurate billing procedures for facilitators of the data packet network.

Demand for communication over data packet networks including, but not limited to, the Internet has increased dramatically. Specifically, the demand has been for the application of conventional (i.e. cellular) telephony technology to data packet networks, including voice over IP (VoIP) service, real time video transmission, text messaging, etc.

Accordingly, facilitators of communication over data packet networks are faced with the challenges of reducing transmission traffic over the data packet network(s), providing more reliable communication tracking and billing methods, and ensuring security and privacy of users of the data packet network(s).

### SUMMARY OF THE INVENTION

The present invention relates to a method for establishing communication over a data packet network that includes: registering an incoming callobject of a first terminal with a location directory service; fetching, by a second terminal, a copy of the incoming callobject of the first terminal from the location directory service; and initiating a communication from the second terminal to the first terminal in accordance with the incoming callobject of the first terminal.

The present invention further relates to a communication system for a data packet network having a location directory service, where the communication system includes: a first terminal which registers an incoming callobject with the location directory service; and a second terminal which fetches a copy of the incoming callobject of the first terminal from the location directory service, and initiates a communication to the first terminal in accordance with the incoming callobject of the first terminal.

### BRIEF DESCRIPTION OF THE DRAWINGS

The scope of the present invention will be apparent from the following detailed description, when taken in conjunction with the accompanying drawings, and such detailed description, while indicating preferred embodiments of the invention, are given as illustrations only, since various changes and modifications within the spirit and scope of the invention will become apparent to those skilled in the art from this detailed description, in which:

FIG. 1 is a block diagram of a network for establishing communication over a data packet network using callobjects according to an example embodiment of the present invention;

FIG. 2 illustrates the incoming callobject and outgoing callobject according to an example embodiment of the present invention;

FIG. 3 is a block diagram of a process for establishing communication over a data packet network using callobjects according to an example embodiment of the present invention;

FIG. 4 shows a flowchart of a process for creation and registration of an incoming call object and an outgoing call object according to an example embodiment of the present invention; and

FIG. 5 shows a flowchart of a process for a first user initiating contact with a second user according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The embodiments of the present invention provide a method and system for establishing communication over a data packet network, which includes, but is not limited to, the Internet, which reduces transmission traffic over the data packet networks, provides more reliable communication tracking and billing methods, and ensures security and privacy for users of the data packet networks.

Each subscriber user of the data packet network may have an outgoing callobject and an incoming callobject stored at either of a local server or the user terminal. Communication over the data packet network is established utilizing the respective callobjects of both the calling party and the call receiving party.

Each subscriber user of the data packet network creates and registers an incoming callobject. Creation includes the user selecting or inputting parameters based on preferences of the user or the user terminal at the user terminal. These parameters may be inputted manually by typing, selected from a menu, or inputted using a Graphical User Interface (GUI) at the terminal. An incoming callobject may then be created including these parameters, other data, and code. An incoming callobject acts as an agent and may be invoked and executed similar to the way a small program or application is invoked and executed. Registration includes storing the incoming callobject at a server or locally at the terminal of the user. The incoming callobject may include a call originating service, a call presentation service, and/or other data and code. The call originating service and call presentation service may be each invoked and executed separately or may be part of the same agent. The call originating service may be registered alone at a location directory service while the call presentation service is stored at either the terminal of the respective subscriber user or together with the call originating service at a server. Further still, the incoming callobject may contain only the incoming callobject call originating service.

The incoming call object (ICO) may be a combination of data and code that includes information needed to call the user (call originating service (COS)) and information related to how to handle calls to the user (call presentation service (CPS)). The ICO may be in the form of one or more applications or other type of executable modules that may be invoked by a user. The user may build the ICO or the ICO may be built by a location server based on user specified information or previously stored information. Once created, the ICO may be registered by storing the ICO at the location server for retrieval by other users desiring to contact this user.

The incoming callobject call originating service includes call receiving capabilities and parameters that are customized by the respective subscriber user. For instance, assuming that the subscriber user's terminal is fully capable, the subscriber user is able to specify the call receiving parameters for communication on the data packet network. Such parameters may include, but are not limited to, call forwarding, call waiting, caller ID, call blocking, voice mail, short message reception, video call reception and specific bandwidth requirements, the user's telephone number, the user's IP address, or configurations for an incoming call.

The call presentation service can be registered to the location directory service as part of the incoming callobject with the call originating service in an incoming callobject package or it can be stored at the local server or terminal independently. The call presentation service identifies the parameters of an incoming call to a subscriber user, thus allowing the subscriber user to dynamically respond to an incoming call. Therefore, the subscriber user may decide to accept the call, forward the call, direct the call to a stored response message, etc. based on the caller, call information parameters, subscriber user parameters, or current situation or status. Once the subscriber user makes this dynamic decision, the incoming callobject call presentation service may handle the incoming call accordingly.

When the incoming callobject call presentation service is located at the terminal or local server of the calling party it may be initialized by the incoming callobject call originating service with the call parameters and transferred to the local terminal or server of the receiving party. Otherwise the incoming callobject call presentation service is already located at the local terminal or server of the receiving party and may be alerted of an incoming call request via messaging.

If the incoming callobject contains only the incoming callobject call originating service, the receiving party may be alerted of an incoming call request without being informed of the parameters of the call.

Moreover, the call presentation service may be created dynamically by the incoming callobject at a call sending terminal after the user requests and receives the incoming callobject of the receiver of the call. In this embodiment, dynamic creation of the call presentation service is possible therefore saving storage of the call presentation service at a server or at the terminal of the receiver of the call. Also, this allows real-time creation based on current conditions or parameters of the user at the sending terminal.

As described above, each subscriber user of the data packet network may also have an outgoing callobject stored at either of the local server or the user terminal. The outgoing callobject includes the outgoing calling capabilities of a subscriber user of the data packet network and may be comprised of data and code. Similar to the incoming callobject, this data and code may be in the form of an application or other type module that may be invoked and executed by a user.

Each subscriber user of the data packet network creates and stores an outgoing callobject. Creation includes the user selecting or inputting parameters based on preferences of the user or the user terminal at the user terminal. These parameters may be inputted manually by typing, selected from a menu, or inputted using a Graphical User Interface (GUI) at the terminal. An outgoing callobject may then be created including these parameters, other data, and code. An outgoing callobject acts as an agent and may be invoked and executed similar to the way a small program or application is invoked and executed. The outgoing callobject may be stored at a server or locally at the terminal of the user. An outgoing callobject stored at either of the local server or the user terminal may include the outgoing calling capabilities of a subscriber user of the data packet network, which include, but are not limited to, speed dialing, voice message data transmission, text data transmission, video data transmission, call monitoring, bandwidth specifications and security checking.

A subscriber user (receiving party) retrieves his/her incoming callobject from either a respective local server or a local terminal, and designates local call receiving capabilities and parameters which are customized by the respective subscriber user. Thus, assuming that the subscriber user's local server and terminal are fully capable of such services, the subscriber user is able to specify the call receiving parameters for communication on the data packet network and include these in the incoming call object, including services related to, but not limited to, call forwarding, call waiting, caller ID, call blocking, voice mail, text message reception, video data reception, supported codecs, supported signaling, and specific bandwidth requirements or configurations for an incoming call. The incoming callobject may store these customized call receiving parameters in the Incoming CallObject Call Originating Service or the receiving party's incoming callobject.

The receiving party may then register the respective incoming callobject in a location directory service (LDS). This includes sending the incoming callobject to the LDS where is may be stored for retrieval by users. The LDS may be either a local service available only to subscriber users of the data packet network or a universal service available to all users of the data packet network.

When a subscriber user (calling party) of the data packet network wants to establish communication with the receiving party, the subscriber user transmits a query to the location directory service, in accordance with the receiving party's logical address. In response to the query, the calling party is able to download a copy of the receiving party's incoming callobject to either the calling party's local server or local terminal.

To actually initiate communication with the receiving party via the data packet network, the calling party then checks whether the outgoing callobject of the calling party is compatible with the receiving party's incoming callobject. That is, the outgoing callobject stored at either of the local server or the user terminal may include the outgoing calling capabilities of a subscriber user of the data packet network, which include, but are not limited to, speed dialing, voice message data transmission, text data transmission, video data transmission, call monitoring, bandwidth specifications and security checking.

If the calling party's outgoing callobject is compatible with the parameters of the receiving party's incoming callobject, specifically the Incoming CallObject Call Originating Service, the calling party initiates communication with the receiving party by transmitting data. Such transmission includes, but is not limited to, placing a telephone call, sending a text message, and sending video data.

If the incoming callobject has been registered in the location directory service with both the Incoming CallObject Call Originating Service and the incoming callobject call presentation service, the incoming callobject call presentation service may be sent to either the local server or local terminal of the receiving party. Thus, the parameters of the incoming call are presented to the receiving party, who is thus able to dynamically respond to the incoming communication from the calling party. That is, the receiving party is able to respond to the copy of the Incoming CallObject Call Originating Service, via the incoming callobject call presentation service, in response to the initial communication from the calling party. The receiving party is still informed of the incoming call when the incoming callobject does not contain the incoming callobject call presentation service, although the parameters of the incoming call may not be presented to the receiving party.

If the communication is accepted by the receiving party, full communication is established between the calling party and the receiving party over the data packet network, utilizing an object transfer protocol, including, but not limited to, H323, Session Initiation Protocol (SIP) and other media package protocols.

As a result of the data packet network communication of the present invention, the calling party is able to control incoming communication, both in terms of who sends communications and the format thereof. Thus, security of such data packet network communication is enhanced.

Furthermore, by first checking for compatibility between the calling party's outgoing callobject and the receiving party's incoming callobject before initiating communication there between, the present invention is able to significantly reduce transmission traffic on the data packet network.

Embodiments according to the present invention also allow improved billing procedures for data packet network communication by monitoring communication using the incoming callobjects.

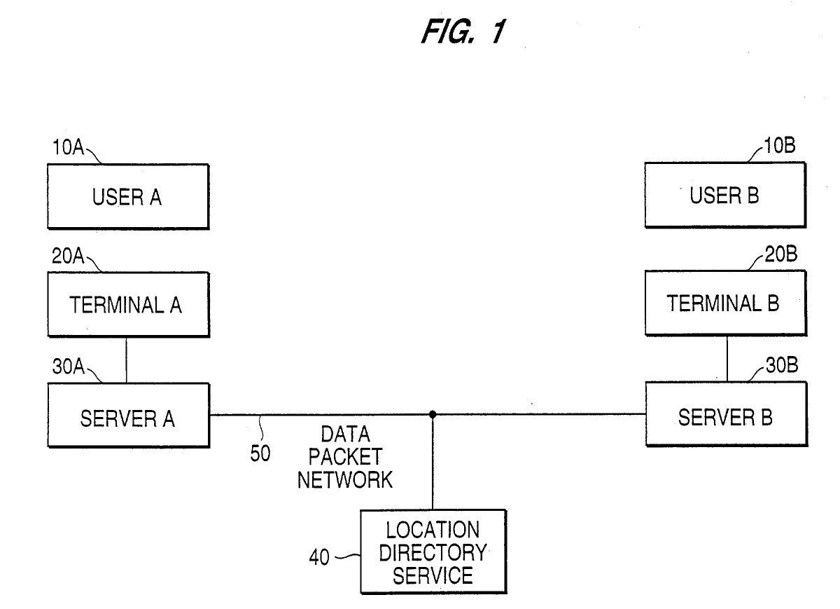

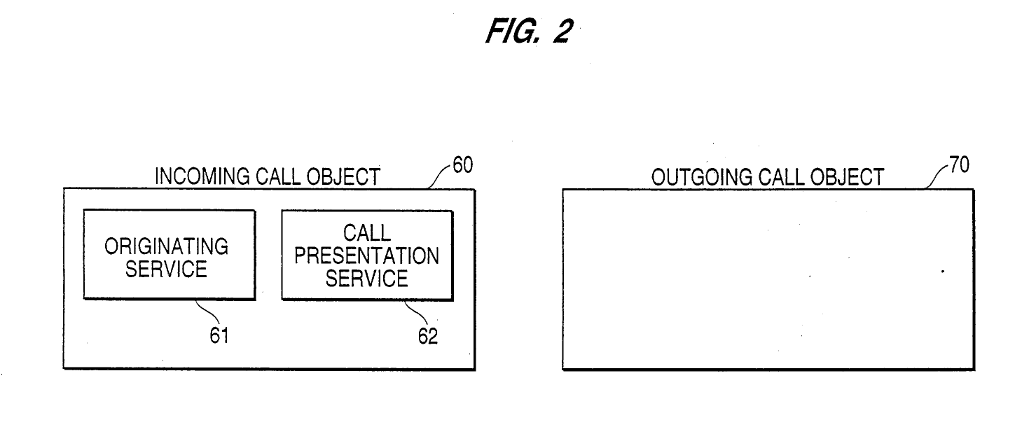

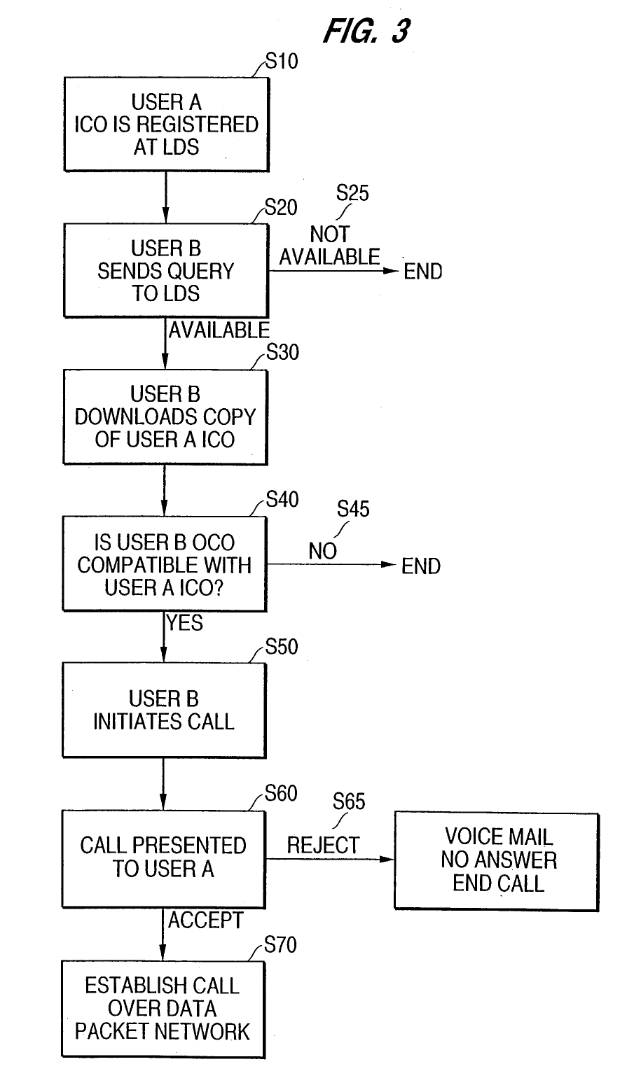

The present invention, as shown in FIG. 1, provides communication between users over a data packet network, which includes, but is not limited to, the Internet. Although the block diagram of FIG. 1 depicts a network connection between only two users, the present invention is applicable to multiple users communicating over a data packet network. The following description of communication between User A 10A and User B 10B includes references to the Incoming CallObject 60 and Outgoing CallObject 70 shown in FIG. 2, and further includes reference to the flow chart of FIG. 3. Although FIG. 2 shows an embodiment of the present invention where a call presentation service is part of the incoming callobject, as noted previously, the incoming callobject may include only the call originating service, where the call presentation service is stored at the terminal of the user. Further still, the following description of communication between User A 10A and User B 10B assumes that User B 10B will be the calling party, attempting to establish communication with User A 10A, via the data packet network, although the Incoming CallObject 60 and Outgoing CallObject 70 are relevant to all such subscriber users of the data packet network.

FIG. 1 shows a flowchart of a process for registering an Incoming CallObject according to an example embodiment of the present invention. A user may connect to a network S1. The network may be any type network that transfers packets, e.g., the Internet. The user may retrieve or download the user's own profile for Voiceover-IP (VoIP) services S2. The VoIP services may be any of many of these type services, for example, traditional PBX like services, (for example, call forwarding, call hunting, call transfer, call waiting, call blocking, caller ID, etc.), messaging like services, (for example, voice message to email, email read through VoIP, voice mail, etc.), video or text announcement to caller if callee not available, profile or location dependent services (e.g., in a meeting room thus send message to caller “in meeting, should I call you later?”, etc.), World Wide Web (WWW)—Voice Integration services (for example, click to contact a web page or text document, web server for service management and user customization, etc.), call barring, special charging, short calling, security checking, short message reception, video call reception, bandwidth requirements, configurations for incoming calls, speed dialing, caller ID, voice message data transmission, text data transmission, video data transmission, call monitoring, etc. A location server may then be located S3. The location server may be a local server or a remote server connected to the network. The user builds an Incoming CallObject.

In order to receive communications via the data packet network which can include, but is not limited to, any network that transfers data packets, e.g., the Internet, User A 10A retrieves or downloads his/her Incoming CallObject 60 which may be stored at either local server 30A or local terminal 20A, to thereby customize the parameters for local call receiving capabilities. That is, assuming that both the local server 30A and terminal 20A are capable of such services, User A 10A specifies the local call receiving capabilities in the Incoming CallObject Call Originating Service 61 of the Incoming CallObject 60.

As an example only, User A 10A can request that all incoming communication be forwarded to another address, and/or specify that certain callers or forms of incoming communication be blocked from establishing communication thereat. Further, User A 10A can specify such call receiving capabilities including caller ID, text message reception, video data reception and even specify bandwidth parameters for incoming communications.

It should be noted that the Incoming CallObject 60 is stored in either the local server 30A or local terminal 20A and is therefore dynamic, and can therefore be customized at any time by User A 10A to change the parameters for local call receiving capabilities.

In step S10, the Incoming CallObject 60 is registered in the location directory service (LDS) 40. LDS 40 is either a local service available only to subscriber users of the data packet network or a universal service available to all users of the data packet network. The Incoming CallObject 60 can be stored in the LDS by an intermediary, including a gatekeeper. Furthermore, the Incoming CallObject 60 that is registered in the LDS 40 includes at least the Incoming CallObject Call Originating Service 61, and can further, but not necessarily, include the Incoming CallObject Call Presentation Service 62. Conversely, the Incoming CallObject Call Presentation Service 62, described below, can be registered at either the local server 30A or local terminal 20A.

In step S20, User b 10B sends a query to LDS 40 in accordance with the logical address for User A 10A, when User B 10B wishes to establish communication with User A 10A via the data packet network 50.

In response to the query, when a match is found between the logical address of User A 10A and the Incoming CallObject 60 of User A 10A, User B 10B is then able to download a copy of the Incoming CallObject 60 registered in the LDS 40 for User A 10A. The copy of the Incoming CallObject 60 for User A 10A is downloaded to either the local server 30B or local terminal 20B corresponding to User B 10B (Step S30). The combination of User B 10B sending the query and User B 10B downloading the Incoming CallObject 60 is known as fetching.

Thus, when User B 10B wishes to initiate communication with User A 10A, a check is made at either the local terminal 20B or local server 30B, to determine if the calling capabilities of User B 10B specified in the Outgoing CallObject 70 are compatible with the customized call receiving capabilities of User A 10A specified in the Incoming CallObject 60 (Step S40). If not, no communication is available between User B 10B and User A 10A, via the data packet network (Step S45).

Next, if the parameters of Outgoing CallObject 70 of User B 10B are compatible with the parameters of Incoming CallObject 60 of User A 10A, User B 10B continues to attempt to establish communication with User A 10A via the data packet network by sending a communication request to User A 10A. If the Incoming CallObject 60 includes both the Incoming CallObject Call Originating Service 61 and the Incoming CallObject Call Presentation Service 62, a communication request along with identification data from the Incoming CallObject Call Presentation Service 62 is transmitted to User A 10A where the parameters of the requested communication from User B 10B is identified (Step S60).

On the other hand, if the Incoming CallObject Call Presentation Service 62 is registered at either the local server 30A or local terminal 20A, the communication request is received thereat so that the Incoming CallObject Call Presentation Service 62 can identify the parameters of the requested communication from User B 10B.

Accordingly, after the parameters of the requested communication are identified in step S60, User A 10A is able to dynamically respond (eg. accept or reject) to the communication request from User B 10B. If the communication request is denied or rejected by User A 10A (Step S65), User B 10B's attempt to establish communication with User A 10A is terminated. However, if User A 10A accepts the communication request, User B 10B is so notified and communication between User B 10B and User A 10A is established via the data packet network 50 (Step S70). The communication is established within the compliant parameters of the Incoming CallObject Call Originating Service 61 and the Outgoing CallObject 70, and is further established utilizing data packet network protocols including, but not limited to, H323, SIP, and various other media transfer packages.

When the Incoming CallObject 60 contains only the Incoming CallObject Call Originating Service 61, the receiving party is still informed of the incoming call, but is not informed of the parameters thereof. Call initialization otherwise remains the same as described above.

Terminals 20A and 20B may be connected to the network via cabling or wiring, or in a wireless fashion. In this regard, the network, servers, and terminals may be part of a wired network, a wireless network, or a network with a combination thereof. Therefore, terminals 20A and 20B may be wired terminals such as, for example, personal computers, workstations, etc., or may be wireless devices such as, for example, portable computers, Personal Data Assistants (PDAs), or mobile phones.

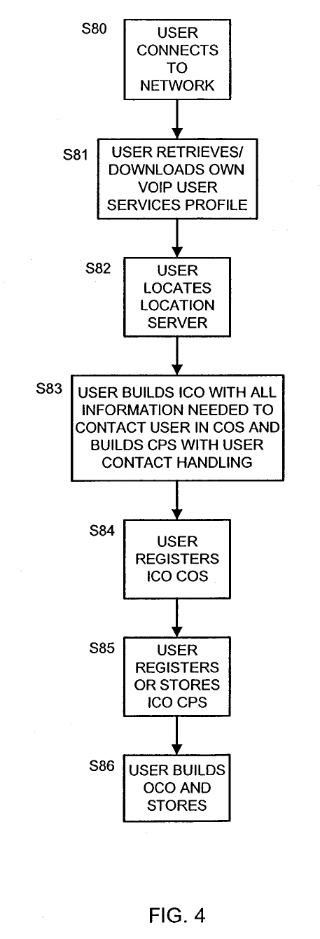

FIG. 4 shows a flowchart of a process for creation and registration of an incoming call object and an outgoing call object according to an example embodiment of the present invention. A User connects to a network S80. The User retrieves/downloads his own user services profile (e.g., Voice Over Internet Protocol (VoIP) profile), S81. The User locates a location server S82. The User builds an incoming call object (ICO), as discussed previously, with all information needed to contact the user in a call originating service (COS) and user contact handling information in a call presentation service (CPS) S83. The User registers the ICO by storing the ICO COS at a server S84. The user stores the CPS locally at the terminal of the user or stores the CPS together with the COS as the ICO at a server S85. The User also builds an outgoing call object (OCO) and may store this locally S86.

The incoming callobject may include a variety of information related to services such as for example, but not limited to, call forwarding, call waiting, caller ID, call blocking, voice mail, text message reception, video data reception, supported codecs, supported signaling, specific bandwidth requirements, the user's telephone number, the user's IP address, configurations for an incoming call, etc. The outgoing call object may include a variety of information related to services such as for example, but not limited to, short dialing, call baring, charging, closed user group, As noted previously the incoming callobject and outgoing callobject may include data and code for implementing these services and may be in the form of an agent application or other type module that may be invoked and executed by a user.

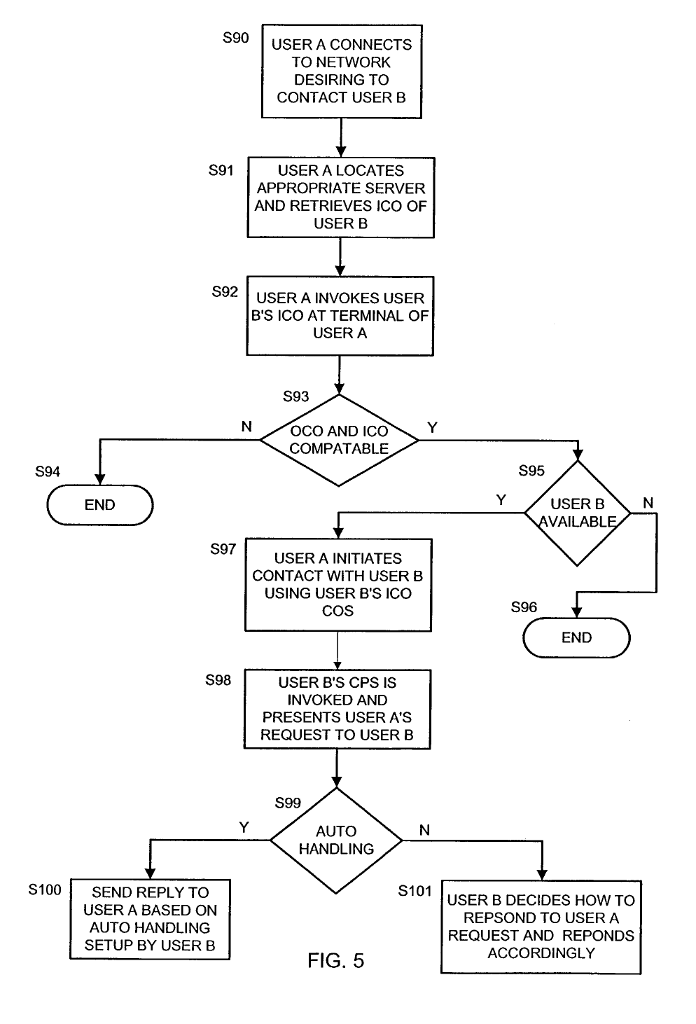

FIG. 5 shows a flowchart of a process for a first user initiating contact with a second user according to an example embodiment of the present invention. User A connects to a network desiring to contact User B S90. The contact desired may include initiating a telephone conversation or the transmission of text, graphics, and/or other data. User A locates the appropriate server on the network that has the incoming callobject of User B and retrieves this ICO S91. User A invokes the ICO of User B at the terminal of User A S92. The ICO may also be self-invoking in that it executes automatically, immediately after retrieval. A check is performed at the terminal of User A to see if parameters related to contact wit User B in User A's outgoing call object (OCO) are compatible with parameters in User B's incoming call object, therefore, allowing communication between the two S93, and if not, the process ends S94. For example, User A may have set up in the OCO not to initiate any international calls, calls/contacts to specific Users, calls during certain days and/or times, or other items as mentioned previously. In this regard, the OCO may serve as a security feature against unauthorized Users of the terminal of User A.

If there is compatibility, a check may be performed to determine if User B is available S95, and if not, the process may end S96. The ICO of User B may present a screen or message at the terminal of User A indicating the availability of User B, and/or information needed to contact User B. For example, User B may have set up in the ICO: specific days and/or times that User B would not be available, an indication that User B is in a meeting or on travel, an indication to contact other individuals, an indication to leave a voice mail message, electronic mail (email), or text message, an indication that User B is no longer connected to the network, etc.

If User B is unavailable, the process ends. Therefore, network resources have not been used and wasted on attempting a contact or call to a user whom is unavailable. If User B is available, User A initiates contact with User B using User B's incoming callobject call origination service S97. User B's incoming callobject call presentation service is invoked at User B and presents User A's request to User B S98. A determination is make as to whether User B has set up automatic handling of this type of contact S99, and if so, a reply is sent to User A based on the automatic handling procedure that has been setup by User B S100. For example, User B may have set up automatic handling of all contacts from User A (or other specific Users). This may include sending back specific messages or routing the call/contact to specific places based on the User. The automatic handling may also be more general in nature where User B is in a meeting, or otherwise unavailable, and has set up automatic handling of all calls/contacts to forward these to a common reply or routing destination (e.g., voice message, email, a server, another User, etc.). If automatic handling is not enabled, User B decides how to respond to the request of User A and responds accordingly S101.

Method and system embodiments for establishing communication over a data packet network using callobjects according to the present invention are advantageous in that they allow the use of efficient VoIP service handling occurs by running call services where the call is initiated, reducing the traffic needed for a call, and using a proxy object if the calling party is not trusted. A subscriber user of a data packet network is able to customize communication receiving capabilities for receiving communications over the data packet network. A result of such customization results in a reduced volume of data transmissions over the data packet network, increased security since a subscriber user is able to control users from whom communications are received as well as the types of communications received, and call tracking is improved, as well, to thus improve billing procedures.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

We claim:

1. A method for establishing communication over a data packet network, said method comprising the steps of:
registering an incoming callobject of a first terminal with a location directory service;
fetching, by a second terminal, a copy of said incoming callobject of said first terminal from said location directory service; and
initiating a communication from said second terminal to said first terminal in accordance with said incoming callobject of said first terminal.

2. A method according to claim 1, wherein said incoming callobject of said first terminal includes an incoming callobject originating service.

3. A method according to claim 2, wherein said incoming callobject originating service includes customized call receiving capability parameters for said first terminal.

4. A method according to claim 3, wherein said customized call receiving capability parameters include call forwarding, call waiting, caller ID, call blocking, voice mail, short message reception, video call reception, and bandwidth specifications.

5. A method according to claim 2, wherein said incoming callobject of said first terminal further includes an incoming callobject call presentation service which identifies parameters of the incoming communication from said second terminal.

6. A method according to claim 5, wherein said incoming callobject call presentation service provides a user of said first terminal with dynamic interaction with said incoming callobject originating service when said second terminal initiates said communication to said first terminal.

7. A method according to claim 5, wherein said parameters of said communication from said second terminal sent from said incoming callobject originating service include caller identification, short message text, voice message data, video message data and bandwidth specifications of said call.

8. A method according to claim 5, wherein said incoming callobject originating service and said incoming callobject call presentation service are registered together in said incoming callobject in said location directory service.

9. A method according to claim 8, wherein said incoming callobject call presentation service is transmitted to said first terminal after said second terminal fetches said incoming callobject of said first terminal from said location directory service.

10. A method according to claim 5, wherein said incoming callobject call originating service is registered in said location directory service and said incoming callobject call presentation service is created and maintained at said first terminal.

11. A method according to claim 2, wherein said second terminal has an outgoing callobject which includes call initiating capabilities of said second terminal.

12. A method according to claim 11, wherein said call initiating capabilities of said second terminal include speed dialing, voice message data transmission, text data transmission, video data transmission, call monitoring, bandwidth specifications of the call and security checking.

13. A method according to claim 11, wherein said incoming callobject of said first terminal is fetched from said location directory service by said second terminal in response to a query from said second terminal.

14. A method according to claim 11, wherein said step of initiating a call from said second terminal to said first terminal includes the sub-steps of:
checking said outgoing callobject of said second terminal to determine if said communication desired by a user of said second terminal complies with the call initiating capabilities of said second terminal;
sending, if said communication desired by a user of said second terminal is determined to comply with the call initiating capabilities of said second terminal, said communication from said outgoing callobject of said second terminal to the incoming callobject originating service of said first terminal; and
sending said communication from said incoming callobject originating service of said first terminal to the user of said first terminal.

15. A method according to claim 14, comprising the further sub-step of:
identifying, by said incoming callobject call presentation service, the parameters of said communication sent from said incoming callobject originating service at said first terminal.

16. A method according to claim 15, wherein said communication sent from said incoming callobject originating service of said first terminal is received by an incoming callobject call presentation service of said first terminal thus allowing the user of said first terminal to dynamically respond to said originating service callobject in response to said communication.

17. A method according to claim 1, wherein if said communication from said second terminal is accepted by a user of said first terminal, communication is established over a data packet network.

18. A method according to claim 17, wherein said data packet network includes the Internet.

19. A method according to claim 18, wherein said data packet network utilizes an H323 protocol standard.

20. A method according to claim 16, wherein if said communication from said second terminal is accepted by a user of said first terminal, communication is established over a data packet network.

21. A method according to claim 20, wherein said data packet network includes the Internet.

22. A method according to claim 21, wherein said data packet network utilizes an H323 protocol standard.

23. A method according to claim 21, wherein said data packet network supports object transfer protocol.

24. A method according to claim 1, wherein said incoming callobject of said first terminal is registered with said location directory service by a user of said first terminal.

25. A method according to claim 1, wherein said incoming callobject of said first terminal is registered with said location directory service by an intermediary.

26. A method according to claim 1, wherein said intermediary is a gatekeeper.

27. A method according to claim 1, wherein said second terminal fetches said incoming callobject of said first terminal directly to said second terminal.

28. A method according to claim 1, wherein said second terminal fetches said incoming callobject of said first terminal to a local server corresponding to said second terminal.

29. A method according to claim 1, wherein said location directory service is a local network directory.

30. A method according to claim 1, wherein said location directory service is a universal directory.

31. A method according to claim 1, wherein said incoming callobject of said first terminal is registered with said location directory service in accordance with a logical address of said first terminal.

32. A method according to claim 1, wherein said incoming callobject is dynamic.

33. A method according to claim 11, wherein said outgoing callobject is dynamic.

34. A communication system for a data packet network having a location directory service, said communication system comprising:
a first terminal which registers an incoming callobject with said location directory service; and
a second terminal which fetches a copy of said incoming callobject of said first terminal from said location directory service, and initiates a communication to said first terminal in accordance with said incoming callobject of said first terminal.

35. A communication system according to claim 34, wherein said incoming callobject of said first terminal includes an incoming callobject originating service.

36. A communication system according to claim 34, wherein said incoming callobject originating service includes customized call receiving capability parameters for said first terminal.

37. A communication system according to 36, wherein said customized call receiving capability parameters include call forwarding, call waiting, caller ID, call blocking, voice mail, short message reception, video call reception, and bandwidth specifications.

38. A communication system according to claim 35, wherein said incoming callobject of said first terminal further includes an incoming callobject call presentation service which identifies parameters of the incoming communication from said second terminal.

39. A communication system according to claim 38, wherein said incoming callobject call presentation service provides a user of said first terminal with dynamic interaction with said incoming callobject originating service when said second terminal initiates said communication to said first terminal.

40. A communication system according to claim 38, wherein said parameters of said communication from said second terminal sent from said incoming callobject originating service include caller identification, short message text, voice message data, video message data and bandwidth specifications of said call.

41. A communication system according to claim 38, wherein said incoming callobject originating service and said incoming callobject call presentation service are registered together in said incoming callobject in said location directory service.

42. A communication system according to claim 41, wherein said incoming callobject call presentation service is transmitted to said first terminal after said second terminal fetches said incoming callobject of said first terminal from said location directory service.

43. A communication system according to claim 38, wherein said incoming callobject call originating service is registered in said location directory service and said incoming callobject call presentation service is created and maintained at said first terminal.

44. A communication system according to claim 35, wherein said second terminal has an outgoing callobject which includes call initiating capabilities of said second terminal.

45. A communication system according to claim 44, wherein said call initiating capabilities of said second terminal include speed dialing, voice message data transmission, text data transmission, video data transmission, call monitoring, bandwidth specifications of the call and security checking.

46. A communication system according to claim 44, wherein said incoming callobject of said first terminal is fetched from said location directory service by said second terminal in response to a query from said second terminal.

47. A communication system according to claim 44, wherein said second terminal initiates said call to said first terminal by checking said outgoing callobject to determine if said communication complies with the call initiating capabilities of said second terminal, sending said communication from said outgoing callobject of said second terminal to the incoming callobject originating service of said first terminal if said communication is determined to comply with the call initiating capabilities of said second terminal, and sending said communication from said incoming callobject originating service of said first terminal to the user of said first terminal.

48. A communication system according to claim 47, wherein said incoming callobject call presentation service identifies the parameters of said communication sent from said incoming callobject originating service at said first terminal.

49. A communication system according to claim 48, wherein said communication sent from said incoming callobject originating service of said first terminal is received by an incoming callobject call presentation service of said first terminal thus allowing the user of said first terminal to dynamically interact with said originating service callobject in response to said communication.

50. A communication system according to claim 34, wherein if said communication from said second terminal is accepted by a user of said first terminal, communication is established over a data packet network.

51. A communication system according to claim 50, wherein said data packet network includes the Internet.

52. A communication system according to claim 51, wherein said data packet network utilizes an H323 protocol standard.

53. A communication system according to claim 49, wherein if said communication from said second terminal is accepted by a user of said first terminal, communication is established over a data packet network.

54. A communication system according to claim 53, wherein said data packet network includes the Internet.

55. A communication system according to claim 54, wherein said data packet network utilizes an H323 protocol standard.

56. A communication system according to claim 54, wherein said data packet network supports object transfer protocol.

57. A communication system according to claim 34, wherein said incoming callobject of said first terminal is registered with said location directory service by a user of said first terminal.

58. A communication system according to claim 34, wherein said incoming callobject of said first terminal is registered with said location directory service by an intermediary.

59. A communication system according to claim 34, wherein said intermediary is a gatekeeper.

60. A communication system according to claim 34, wherein said second terminal fetches said incoming callobject of said first terminal directly to said second terminal.

61. A communication system according to claim 34, wherein said second terminal fetches said incoming callobject of said first terminal to a local server corresponding to said second terminal.

62. A communication system according to claim 34, wherein said location directory service is a local network directory.

63. A communication system according to claim 34, wherein said location directory service is a universal directory.

64. A communication system according to claim 34, wherein said incoming callobject of said first terminal is registered with said location directory service in accordance with a logical address of said first terminal.

65. A communication system according to claim 34, wherein said incoming callobject is dynamic.

66. A communication system according to claim 44, wherein said outgoing callobject is dynamic.
